(19) United States
(12) Patent Application Publication
(10) Pub. No.: US 2026/0230728 A1
(43) Pub. Date: Aug. 6, 2026

(54) IMAGING DEVICE

(71) Applicant: Mitsubishi Electric Corporation, Tokyo (JP)

(72) Inventors: Tetsuya HEIMA, Tokyo (JP); Masaharu HATTORI, Tokyo (JP); Tomohiro MAEGAWA, Tokyo (JP)

(73) Assignee: Mitsubishi Electric Corporation, Tokyo (JP)

(21) Appl. No.: 19/152,434

(22) PCT Filed: Jun. 12, 2023
(86) PCT No.: PCT/JP2023/021772

§ 371 Date: Jul. 30, 2025

(51) Int. Cl. H04N 25/709; H04N 25/778

(52) U.S. Cl. CPC H04N 25/709; H04N 25/778

(57) ABSTRACT

A plurality of pixels (2) are formed in a matrix on a semiconductor chip (1). Each pixel (2) includes a hollow pixel (3) and a non-hollow reference pixel (4) that are adjacent to each other. A differential amplifier (6) amplifies an output voltage difference between the hollow pixel (3) and the non-hollow reference pixel (4) that are adjacent to each other.

### FIELD

The present disclosure relates to an imaging device.

### BACKGROUND

Identical pixels are disposed in a matrix in a pixel array unit of an imaging device. An imaging device including an environmental temperature detection unit for detecting a change in chip temperature to allow an output voltage to have a value corresponding to environment conditions has been proposed (see, for example, PTL 1).

### CITATION LIST

### Patent Literature

[PTL 1] JP 2006-314025 A

### SUMMARY OF THE INVENTION

### Problems to be Solved by the Invention

Conventionally, since the environmental temperature detection unit was provided at an edge of a chip and away from the pixel array unit, a temperature difference occurred between the environmental temperature detection unit and the pixel array, which resulted in lowered measurement accuracy. Thus, it was impossible to eliminate temperature distribution and process variations within a chip surface. Consequently, fixed pattern noise (FPN) became larger, and the required ENOB for an AD converter connected in a subsequent stage increased.

Moreover, calibration was required to regulate the voltage output from each pixel when a shutter is closed so that the voltage is constant within the surface. The output voltage of each pixel needs to be stable during calibration, but the output voltage usually varies with a change in chip temperature. Therefore, even when calibration using the shutter was performed in a state of transition of temperature of the chip such as during activation of the device or when the device was being warmed by sunlight, it was impossible to correctly output the temperature of a subject.

The present disclosure has been made to solve the above-mentioned problems, and an object of the disclosure is to provide an imaging device capable of mitigating the influences of variation within the chip surface and the transition of temperature of the chip.

### Solution to Problem

An imaging device according to the present disclosure includes a semiconductor chip;
a plurality of pixels formed in a matrix on the semiconductor chip; and a differential amplifier, wherein each pixel includes a hollow pixel and a non-hollow reference pixel that are adjacent to each other, and the differential amplifier amplifies an output voltage difference between the hollow pixel and the non-hollow reference pixel that are adjacent to each other.

### Advantageous Effects of Invention

In the present disclosure, the non-hollow reference pixel is disposed adjacent to the hollow pixel in each pixel and the output voltage difference between these pixels is found.

Consequently, the influences of variation within the chip surface, such as process variation or temperature variation, and the transition of temperature of the chip can be mitigated.

### BRIEF DESCRIPTION OF THE DRAWINGS

FIG. 1 is a plan view showing an imaging device according to Embodiment 1.

FIG. 2 is a circuit diagram showing the imaging device according to Embodiment 1.

FIG. 3 is a cross-sectional view showing a hollow pixel.

FIG. 4 is a cross-sectional view showing a non-hollow reference pixel.

FIG. 5 is a diagram showing the output voltage of the hollow pixel.

FIG. 6 is a diagram showing the output voltages of the hollow pixel and the non-hollow reference pixel through which the same bias current is passed.

FIG. 7 is a diagram showing the output voltages of the hollow pixel and the non-hollow reference pixel according to Embodiment 1.

FIG. 8 is a plan view showing an imaging device according to Embodiment 2.

FIG. 9 is a diagram showing a subsequent stage of the differential amplifier of the imaging device according to Embodiment 2.

FIG. 10 is a diagram showing the functions of the imaging device according to Embodiment 2.

FIG. 11 is a plan view showing an imaging device according to Embodiment 3.

FIG. 12 is a circuit diagram showing an imaging device according to Embodiment 4.

FIG. 13 is a plan view showing an imaging device according to Embodiment 5.

FIG. 14 is a plan view showing a modification of the imaging device according to Embodiment 5.

### DESCRIPTION OF EMBODIMENTS

An imaging device according to the embodiments of the present disclosure will be described with reference to the drawings. The same components will be denoted by the same symbols, and the repeated description thereof may be omitted.

### Embodiment 1

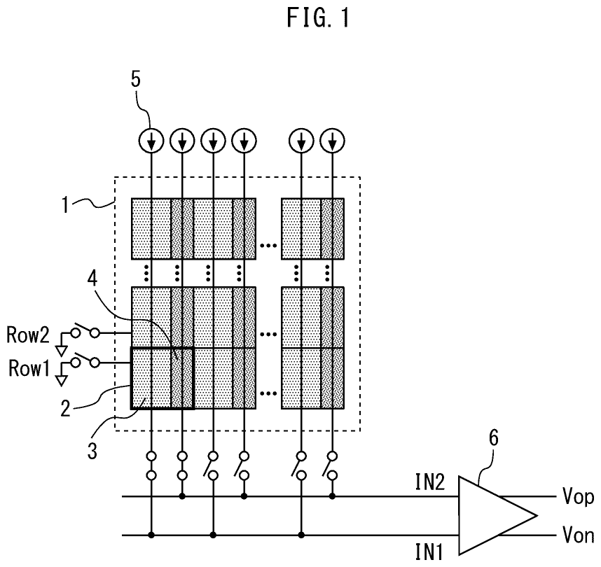

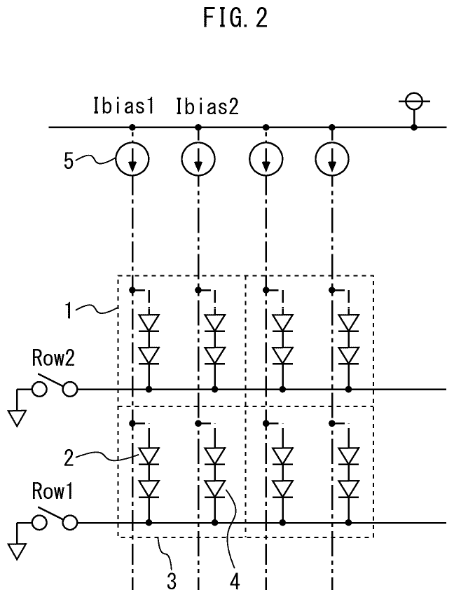

FIG. 1 is a plan view showing an imaging device according to Embodiment 1. FIG. 2 is a circuit diagram showing the imaging device according to Embodiment 1. This imaging device is an infrared sensor that detects infrared radiation. A plurality of pixels 2 are formed in a matrix on a semiconductor chip 1. Each pixel 2 includes a hollow pixel 3 and a non-hollow reference pixel 4 that are adjacent to each other.

A current source 5 supplies a bias current individually to each of the hollow pixels 3 arranged in a column and the non-hollow reference pixels 4 arranged in a column. A first input terminal IN1 of a differential amplifier 6 is connected to the output of the hollow pixels 3 arranged in a column. A second input terminal IN2 of the differential amplifier 6 is connected to the output of the non-hollow reference pixels 4 arranged in a column. When a switch Rowl is turned on, each of the hollow pixels 3 and the non-hollow reference pixels 4 in the corresponding row becomes active and outputs an output voltage. Similarly, when a switch Row2 is turned on, each of the hollow pixels 3 and the non-hollow reference pixels 4 in the corresponding row becomes active and outputs an output voltage. The differential amplifier 6 amplifies the difference in output voltage between the hollow pixels 3 and the non-hollow reference pixels 4 that are adjacent to each other.

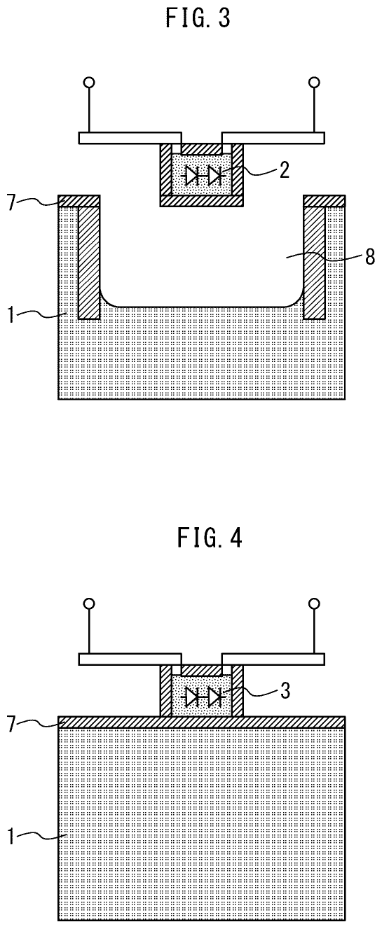

FIG. 3 is a cross-sectional view showing a hollow pixel. The semiconductor chip 1 is, for example, a silicon substrate. An oxide film 7 is formed on a surface of the semiconductor chip 1. A recess 8 is formed in a portion of the surface of the semiconductor chip 1. The hollow pixel 3 is disposed in a hollow state above the recess 8. The hollow pixel 3 is a diode that is thermally vacuum insulated from the semiconductor chip 1.

FIG. 4 is a cross-sectional view showing a non-hollow reference pixel. The non-hollow reference pixel 4 is in contact with the semiconductor chip 1 through the oxide film 7 and is thermally connected to the semiconductor chip 1. Therefore, the non-hollow reference pixel 4 is prone to heat dissipation. Consequently, a temperature rise of the non-hollow reference pixel 4 due to self-heating and infrared emission does not occur, and the diode of the non-hollow reference pixel 4 generates a potential difference corresponding to the temperature of the semiconductor chip 1. Hence, the non-hollow reference pixel 4 functions as a reference voltage generation circuit that outputs a voltage corresponding to the chip temperature.

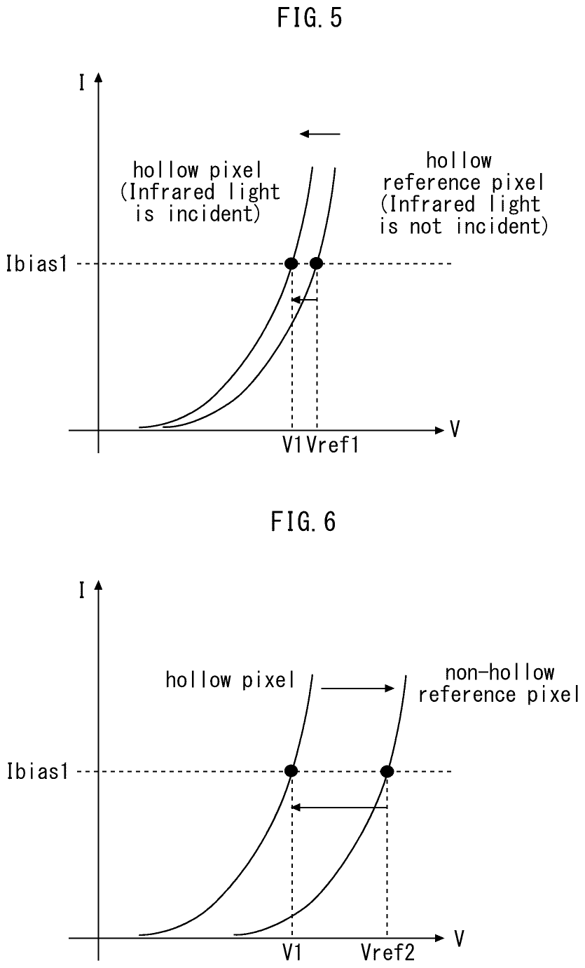

FIG. 5 is a diagram showing the output voltage of the hollow pixel. Since the periphery of the hollow pixel 3 is in a vacuum state, heat dissipation from the hollow pixel 3 to the semiconductor chip 1 is reduced. Consequently, when a bias current Ibias1 is passed through the hollow pixel 3 and infrared radiation is emitted from a subject, a temperature rise occurs in the hollow pixel 3 due to self-heating and infrared emission, and the potential difference between both terminals of the diode of the hollow pixel 3 changes from Vref1 to V1. This makes it possible to measure the temperature of the subject.

FIG. 6 is a diagram showing the output voltages of the hollow pixel and the non-hollow reference pixel through which the same bias current is passed. By taking the output voltage difference between adjacent hollow pixel 3 and non-hollow reference pixel 4, the influence of the temperature of the semiconductor chip 1 can be eliminated, and a potential difference corresponding to the temperature of the subject can be output. Note that, if the same bias current Ibias1 is passed through the hollow pixel 3 and the non-hollow reference pixel 4, a temperature rise of the diode due to self-heating of the thermally insulated hollow pixel 3 becomes too large relative to a temperature rise of the diode in the non-hollow reference pixel 4. Consequently, the potential difference to be input to the differential amplifier 6 in the subsequent stage becomes too large, and the output of the differential amplifier 6 may be saturated.

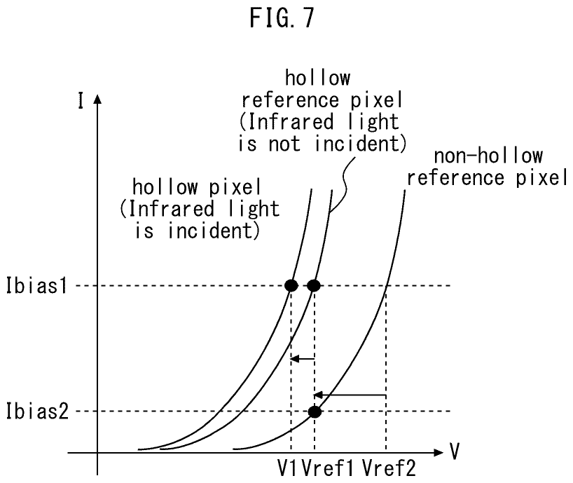

FIG. 7 is a diagram showing the output voltages of the hollow pixel and the non-hollow reference pixel according to Embodiment 1. The current source 5 causes a bias current Ibias2 to the non-hollow reference pixel 4 to be lower than the bias current Ibias1 to the hollow pixel 3 so that the output voltage difference between the hollow pixel 3 and the non-hollow reference pixel 4 in a state in which no infrared radiation is incident becomes smaller. Consequently, since the potential difference to be input to the differential amplifier 6 becomes smaller, saturation of the differential amplifier 6 can be avoided. Note that the current source 5 preferably regulates the bias current Ibias 1 and the bias current Ibias2 so that the output voltage of the hollow pixel 3 and the output voltage of the non-hollow reference pixel 4 in the state in which no infrared radiation is incident become the same.

As described above, in the present embodiment, the non-hollow reference pixel 4 is disposed adjacent to the hollow pixel 3 in each pixel 2, and the output voltage difference between these pixels is found. Consequently, the influences of variation within the chip surface, such as process variation or temperature variation, and the transition of temperature of the chip can be mitigated.

Moreover, the non-hollow reference pixel 4 is prepared by changing the diode of the hollow pixel 3 to a non-hollow type, and has the same diode structure as the hollow pixel 3. Consequently, since the hollow pixel 3 and the non-hollow reference pixel 4 change in the same manner with respect to process variation, the influence of process variation within the chip surface is mitigated. Furthermore, by eliminating the variation within the chip surface, calibration using a shutter is not required.

### Embodiment 2

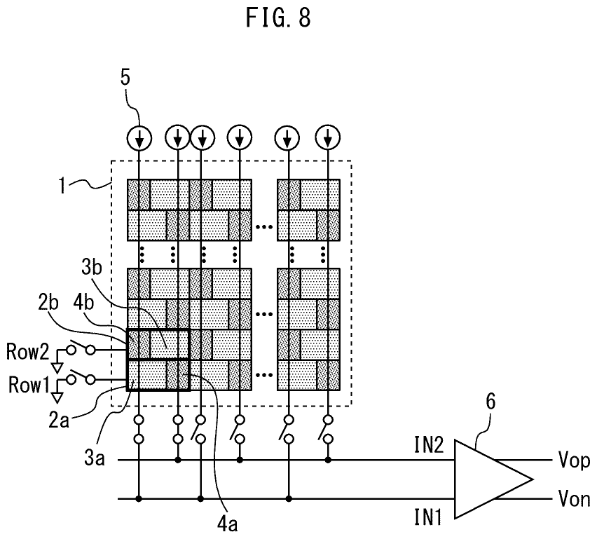

FIG. 8 is a plan view showing an imaging device according to Embodiment 2. Each pixel 2 is divided into a first region 2a and a second region 2b. When the size of each pixel is 50×50 μm, the size of each of the first region 2a and the second region 2b is 50×25 μm.

Each hollow pixel 3 includes a first hollow pixel 3a and a second hollow pixel 3b. Each non-hollow reference pixel 4 includes: a first non-hollow reference pixel 4a adjacent to the first hollow pixel 3a; and a second non-hollow reference pixel 4b adjacent to the second hollow pixel 3b.

The first hollow pixel 3a and the first non-hollow reference pixel 4a are formed in the first region 2a. The second hollow pixel 3b and the second non-hollow reference pixel 4b are formed in the second region 2b in reverse order relative to the first hollow pixel 3a and the first non-hollow reference pixel 4a. The first hollow pixel 3a and the second non-hollow reference pixel 4b are connected to the first input terminal IN1. The second hollow pixel 3b and the first non-hollow reference pixel 4a are connected to the second input terminal IN2.

The hollow pixel 3 and the non-hollow reference pixel 4 are both present in the same column. Then, the current source 5 causes the bias current to the non-hollow reference pixel 4 to be lower than the bias current to the hollow pixel 3 as in the first embodiment by switching the bias current Ibias1 and the bias current Ibias2 using a cross switch.

When the switch Row1 is turned on, the differential amplifier 6 receives the output voltage of the first hollow pixel 3a from the first input terminal IN1, receives the output voltage of the first non-hollow reference pixel 4a from the second input terminal IN2, and outputs a first output signal. When the switch Row2 is turned on, the differential amplifier 6 receives the output voltage of the second hollow pixel 3b from the second input terminal IN2, receives the output voltage of the second non-hollow reference pixel 4b from the first input terminal IN1, and outputs a second output signal.

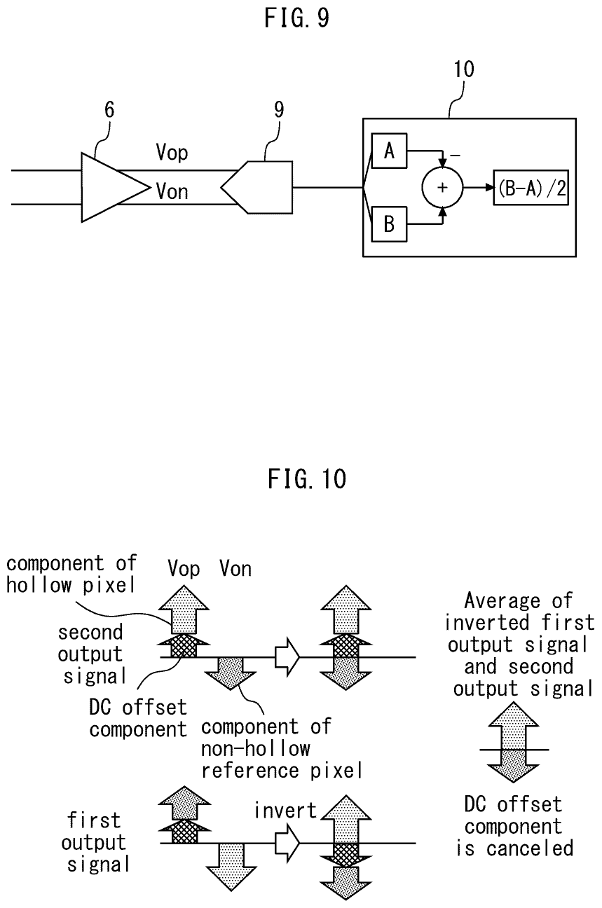

FIG. 9 is a diagram showing a subsequent stage of the differential amplifier of the imaging device according to Embodiment 2. An AD converter 9 and an inverting averaging circuit 10 are connected in the subsequent stage of the differential amplifier 6. The AD converter 9 and the inverting averaging circuit 10 can be configured as an ASIC, or can be built in a sensor IC. The AD converter 9 converts the magnitude of the output voltage of the differential amplifier 6 into a digital signal. The digitized first output signal is input to A of the inverting averaging circuit 10, and the digitized second output signal is input to B of the inverting averaging circuit 10. The inverting averaging circuit 10 finds the average of the inverted first output signal and the second output signal of the differential amplifier 6.

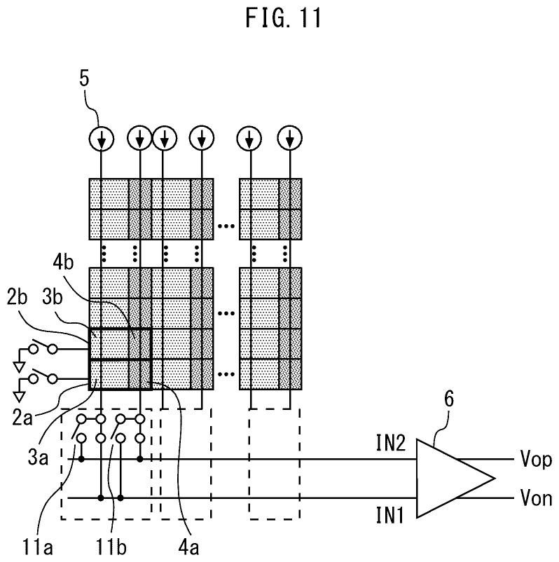

FIG. 10 is a diagram showing the functions of the imaging device according to Embodiment 2. Since there is manufacturing variation in the differential amplifier 6, a DC offset that is an extra voltage is added to the input side of the differential amplifier 6. Therefore, the DC offset component is added to an output voltage Vop of the differential amplifier 6. Then, the inverting averaging circuit 10 finds the average of the inverted first output signal and the second output signal. This makes it possible to cancel the DC offset component. Consequently, the accuracy of measuring the temperature of the subject is improved.

### Embodiment 3

FIG. 11 is a plan view showing an imaging device according to Embodiment 3. A first switch 11a connects the first hollow pixel 3a and the second hollow pixel 3b to one of the first input terminal IN1 and the second input terminal IN2. A second switch 11b connects the first non-hollow reference pixel 4a and the second non-hollow reference pixel 4b to the other of the first input terminal IN1 and the second input terminal IN2.

By switching the first switch 11a and the second switch 11b, the differential amplifier 6 receives the output voltage of the first hollow pixel 3a from the first input terminal IN1, receives the output voltage of the first non-hollow reference pixel 4a from the second input terminal IN2, and outputs the first output signal. Further, by switching the first switch 1 la and the second switch 11b, the differential amplifier 6 receives the output voltage of the second hollow pixel 3b from the second input terminal IN2, receives the output voltage of the second non-hollow reference pixel 4b from the first input terminal IN1, and outputs the second output signal. The inverting averaging circuit 10 finds the average of the inverted first output signal and the second output signal. This makes it possible to obtain the same effect as that of Embodiment 2.

### Embodiment 4

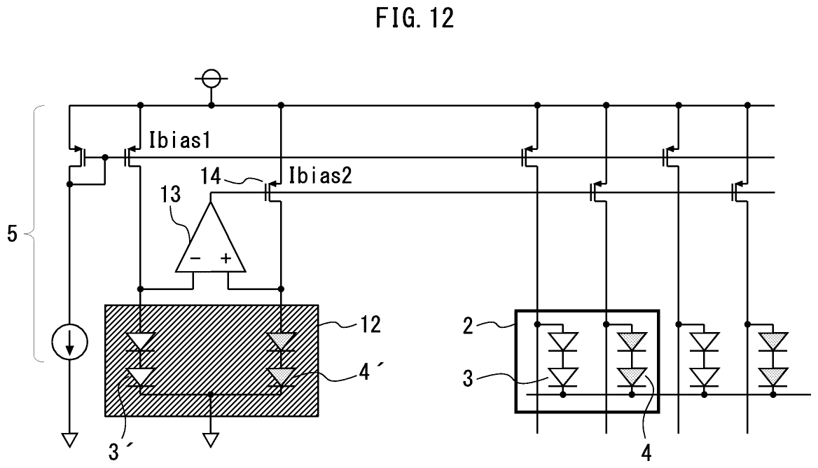

FIG. 12 is a circuit diagram showing an imaging device according to Embodiment 4. The output voltages of a hollow reference pixel 3′ and a non-hollow reference pixel 4′ disposed in a light-shielded region 12 are input to an operational amplifier 13. The structure of the hollow reference pixel 3′ is the same as that of hollow pixel 3. The structure of the non-hollow reference pixel 4′ is the same as that of non-hollow reference pixel 4. The current source 5 passes the bias current Ibias1 as a reference to the hollow reference pixel 3′. An output from the operational amplifier 13 is input to a transistor 14 of the current source 5 to control the bias current Ibias2 of the non-hollow reference pixel 4′. In other words, the current source 5 controls the bias current Ibias2 according to the output of the operational amplifier 13 so as to equalize the output voltages of the hollow reference pixel 3′ and the non-hollow reference pixel 4′ disposed in the light-shielded region 12 (see FIG. 7). Note that the bias current Ibias1 may be controlled according to the output of the operational amplifier 13 with the bias current Ibias2 as a reference.

The currents equal to or proportional to the hollow reference pixel 3′ and the non-hollow reference pixel 4′ in the light-shielded region 12 are passed respectively to the hollow pixel 3 and the non-hollow reference pixel 4 in a non-light-shielded pixel array unit by a current mirror or the like. Consequently, since the potential difference to be input to the differential amplifier 6 becomes smaller, saturation of the differential amplifier 6 can be avoided. Other configurations and effects are the same as those in Embodiment 1.

### Embodiment 5

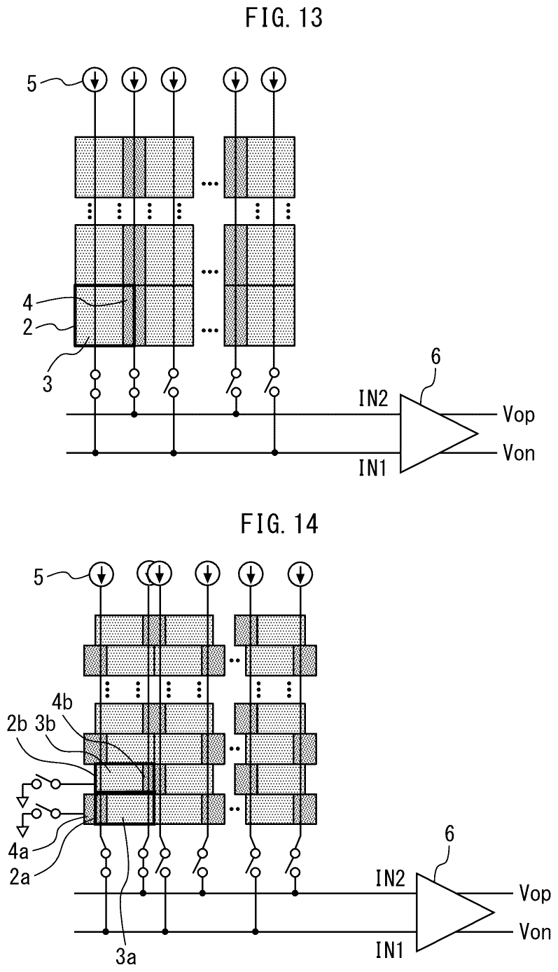

FIG. 13 is a plan view showing an imaging device according to Embodiment 5. In this embodiment, the hollow pixels 3 and the non-hollow reference pixels 4 in each even-numbered column in Embodiment 1 are swapped, and the hollow pixels 3 and the non-hollow reference pixels 4 in adjacent odd-numbered column are shared. In other words, adjacent pixels 2 share the non-hollow reference pixel 4 in the configuration of Embodiment 1. Consequently, since the area occupied by the non-hollow reference pixel 4 in each pixel 2 becomes smaller, the area of the hollow pixel 3 can be expanded.

FIG. 14 is a plan view showing a modification of the imaging device according to Embodiment 5. Adjacent pixels 2 share the non-hollow reference pixel 4 in the configuration of Embodiment 2. Consequently, since the area occupied by the non-hollow reference pixel 4 in each pixel 2 becomes smaller, the area of the hollow pixel 3 can be expanded.

### REFERENCE SIGNS LIST

1 semiconductor chip, 2 pixel, 2a first region, 2b second region, 3 hollow pixel, 3a first hollow pixel, 3b second hollow pixel, 4 non-hollow reference pixel, 4a first non-hollow reference pixel, 4b second non-hollow reference pixel, 5 current source, 6 differential amplifier, 10 inverting averaging circuit, 11a first switch, 11b second switch, 13 operational amplifier, IN1 first input terminal, IN2 second input terminal

1. An imaging device comprising:
a semiconductor chip;
a plurality of pixels formed in a matrix on the semiconductor chip; and
a differential amplifier; and
a current source,
wherein each pixel includes a hollow pixel and a non-hollow reference pixel that are adjacent to each other,
the differential amplifier amplifies an output voltage difference between the hollow pixel and the non-hollow reference pixel that are adjacent to each other,
the current source supplies bias currents to the hollow pixel and the non-hollow reference pixel, and
the current source causes the bias current to the non-hollow reference pixel to be lower than the bias current to the hollow pixel so that the output voltage difference between the hollow pixel and the non-hollow reference pixel in a state in which no infrared radiation is incident becomes smaller.

2. The imaging device according to claim 1, wherein the hollow pixel is thermally insulated from the semiconductor chip, and
the non-hollow reference pixel is thermally connected to the semiconductor chip.

3. The imaging device according to claim 2, wherein the non-hollow reference pixel has the same diode structure as the hollow pixel.

4. (canceled)

5. An imaging device comprising:
a semiconductor chip;
a plurality of pixels formed in a matrix on the semiconductor chip; and
a differential amplifier; and
an inverting averaging circuit connected in a subsequent stage of the differential amplifier,
wherein each pixel includes a hollow pixel and a non-hollow reference pixel that are adjacent to each other,
the differential amplifier amplifies an output voltage difference between the hollow pixel and the non-hollow reference pixel that are adjacent to each other,
the hollow pixel includes a first hollow pixel and a second hollow pixel,
the non-hollow reference pixel includes a first non-hollow reference pixel adjacent to the first hollow pixel, and a second non-hollow reference pixel adjacent to the second hollow pixel,
the differential amplifier includes a first input terminal and a second input terminal,
the differential amplifier receives output voltage of the first hollow pixel from the first input terminal, receives output voltage of the first non-hollow reference pixel from the second input terminal, and outputs a first output signal,
the differential amplifier receives output voltage of the second hollow pixel from the second input terminal, receives output voltage of the second non-hollow reference pixel from the first input terminal, and outputs a second output signal, and
the inverting averaging circuit finds an average of the inverted first output signal and the second output signal.

6. The imaging device according to claim 5, wherein each pixel is divided into a first region and a second region,
the first hollow pixel and the first non-hollow reference pixel are formed in the first region,
the second hollow pixel and the second non-hollow reference pixel are formed in the second region in reverse order relative to the first hollow pixel and the first non-hollow reference pixel,
the first hollow pixel and the second non-hollow reference pixel are connected to the first input terminal, and
the second hollow pixel and the first non-hollow reference pixel are connected to the second input terminal.

7. The imaging device according to claim 5, further comprising a first switch connecting the first hollow pixel and the second hollow pixel to one of the first input terminal and the second input terminal, and
a second switch connecting the first non-hollow reference pixel and the second non-hollow reference pixel to the other of the first input terminal and the second input terminal.

8. The imaging device according to claim 41, comprising an operational amplifier to which output voltages of a hollow reference pixel and a non-hollow reference pixel disposed in a light-shielded region are input,
wherein the current source controls a bias current of the hollow pixel or a bias current of the non-hollow reference pixel according to an output of the operational amplifier.

9. The imaging device according to claim 1, wherein adjacent pixels share the non-hollow reference pixel.

10. The imaging device according to claim 5, wherein each hollow pixel is thermally insulated from the semiconductor chip, and
each non-hollow reference pixel is thermally connected to the semiconductor chip.

11. The imaging device according to claim 10, wherein the non-hollow reference pixel has the same diode structure as the hollow pixel.

12. The imaging device according to claim 5, wherein adjacent pixels share the non-hollow reference pixel.
